(19) United States
(12) Patent Application Publication
(10) Pub. No.: US 2013/0228653 A1
(43) Pub. Date: Sep. 5, 2013

(54) ELECTROTHERMAL AND ELECTRO EXPULSIVE HYBRID ICE PROTECTION SYSTEM FOR ENGINE INLET

(71) Applicant: SPIRIT AEROSYSTEMS, INC., Wichita, KS (US)

(72) Inventors: Marlin D. Breer, Wichita, KS (US); Brandon C. Clarke, West Chester, OH (US); Kevin Michael Wiedenmann, Andover, KS (US); Roger E. Kornfeld, Whitewater, KS (US); Kevin L. Obrachta, Wichita, KS (US); Neal G. Rolfes, Wichita, KS (US)

(73) Assignee: SPIRIT AEROSYSTEMS, INC., Wichita, KS (US)

(21) Appl. No.: 13/678,906

(22) Filed: Nov. 16, 2012

Related U.S. Application Data
(60) Provisional application No. 61/560,995, filed on Nov. 17, 2011.

(51) Int. Cl. B64D 15/12; B64D 15/16

(52) U.S. Cl. CPC B64D 15/12; B64D 15/163
USPC 244/134 D

(57) ABSTRACT

A hybrid ice protection system (HIPS) including both an electro-expulsive de-icing system (EEDS) and electrothermal heaters to first break ice away from an outer surface of an engine nacelle inlet lip and then melt remaining residual ice from the outer surface of the inlet lip. The EEDS may have a plurality of EEDS actuators positioned to provide striking force to inner surfaces of both outer and inner walls of the inlet lip. The electrothermal heaters may be positioned to heat the inlet lip at areas between locations where the EEDS actuators provide striking force. The HIPS may also include a control system for actuating the EEDS actuators to strike the inner surface of the inlet lip when the inlet lip is at or below a predetermined temperature and then activating the electrothermal heaters to remove residual ice left on the inlet lip after actuation of the EEDS actuators.

### RELATED APPLICATIONS

This application claims priority benefit of a provisional application entitled, “Electrothermal and Electro Expulsive Hybrid Ice Protection System for Engine Inlet,” Ser. No. 61/560,995, filed Nov. 17, 2011 and incorporated by reference herein in its entirety.

### BACKGROUND

During flight, various portions of an aircraft, such as an engine inlet, can become coated in ice due to cold air containing moisture. This can be detrimental to the aerodynamics and operation of the aircraft. To combat this, heating elements or electro expulsive de-icing systems (EEDS) may be inserted into the engine inlet to de-ice the lip skin of the engine inlet. The EEDS may include actuators which hit or vibrate the lip skin in an attempt to break the ice off of the inlet lip skin.

While an EEDS may effectively remove ice formations from the inlet lip skin, significant quantities of small “feathers” of ice residue may still remain attached to the lip skin surface after application of an EEDS firing sequence. Because these “feathers” have very little mass, the impact acceleration of the EEDS actuators is unable to generate sufficient force to overcome the adhesion of the feathers to the lip skin surface. Thus, EEDS alone does not provide ideal ice protection for a jet engine inlet in all possible icing conditions.

Another method of removing ice from an engine inlet is through the use of heaters installed within the inlet. However, this requires a large amount of energy to completely melt the ice from the engine inlet and is not as efficient as other ice removal methods.

### SUMMARY

Embodiments of the present invention solve the above-mentioned problems and provide a distinct advance in the art of de-icing of aircraft components. An embodiment of the invention is a hybrid ice protection system (HIPS) for use in an aircraft engine inlet lip to first break ice away from an outer surface of the engine inlet lip and then melt remaining residual ice or ice feathers from the inlet lip. The HIPS may include both an electro-expulsive de-icing system (EEDS) for striking an inner surface of the inlet lip and electrothermal heaters for heating the inlet lip to melt residual ice. The EEDS may have a plurality of EEDS actuators positioned to provide striking force to inner surfaces of both outer and inner walls of the inlet lip. The electrothermal heaters may be positioned to heat the inlet lip at areas between locations where the EEDS actuators provide striking force, so that the EEDS actuators do not strike the electrothermal heaters, only the inner surface of the inlet lip. The HIPS may also include a control system for actuating the EEDS actuators to strike the inner surface of the inlet lip when the inlet is at or below a predetermined temperature and then activating the electrothermal heaters to remove residual ice left on the inlet lip after actuation of the EEDS actuators.

Another embodiment of the invention is a method for expelling ice from an outer surface of an inlet lip of an engine nacelle. The method may include the steps of actuating electro-expulsive de-icing system (EEDS) actuators to strike an inner surface of the inlet lip and activating electrothermal heaters to heat the outer surface of the inlet lip between locations where the EEDS actuators strike the inlet lip after actuating the EEDS actuators. The EEDS actuators may be actuated to strike the inlet lip when the inlet lip is at or below a predetermined temperature and/or has a predetermined amount of ice thereon. The electrothermal heaters may only be activated if less than a maximum amount of residual ice build up is present on the outer surface of the inlet lip. Furthermore, the method may include the step of shutting off the electrothermal heaters once a predetermined maximum threshold temperature is reached. Then the method may again repeat the step of actuating the EEDS actuators once the inlet lip outer surface cools and/or a sufficient amount of ice has again built up on the outer surface of the inlet lip.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a fragmentary cross-sectional side view of an engine nacelle comprising an engine inlet lip constructed in accordance with an embodiment of the present invention;

FIG. 2 is a perspective view of a hybrid ice protection system (HIPS) configured to be positioned within the engine inlet lip and to remove ice from an outer surface of the engine inlet lip using both an electro-expulsive de-icing system (EEDS) and electro-thermal heaters;

FIG. 3 is a perspective view of the EEDS of FIG. 2 and an actuator support assembly (ASA) for supporting and attaching the EEDS to the engine nacelle of FIG. 1;

FIG. 4 is a cross-sectional view taken along line 4-4 of FIG. 3, including the engine inlet lip of FIG. 1, the electro-thermal heaters of FIG. 2, actuators of the EEDS, and the ASA;

FIG. 5 is a close-up perspective view of an actuator end support of the ASA for holding and preventing damage to actuator ends of the EEDS of FIG. 2; and

FIG. 6 is a flow chart illustrating a method of removing ice from an engine inlet lip in accordance with an embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention is intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the present invention is defined only by claims presented in subsequent regular utility applications, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, step, etc. described in one embodiment may also be included in other embodiments, but is not necessarily included. Thus, the present technology can include a variety of combinations and/or integrations of the embodiments described herein.

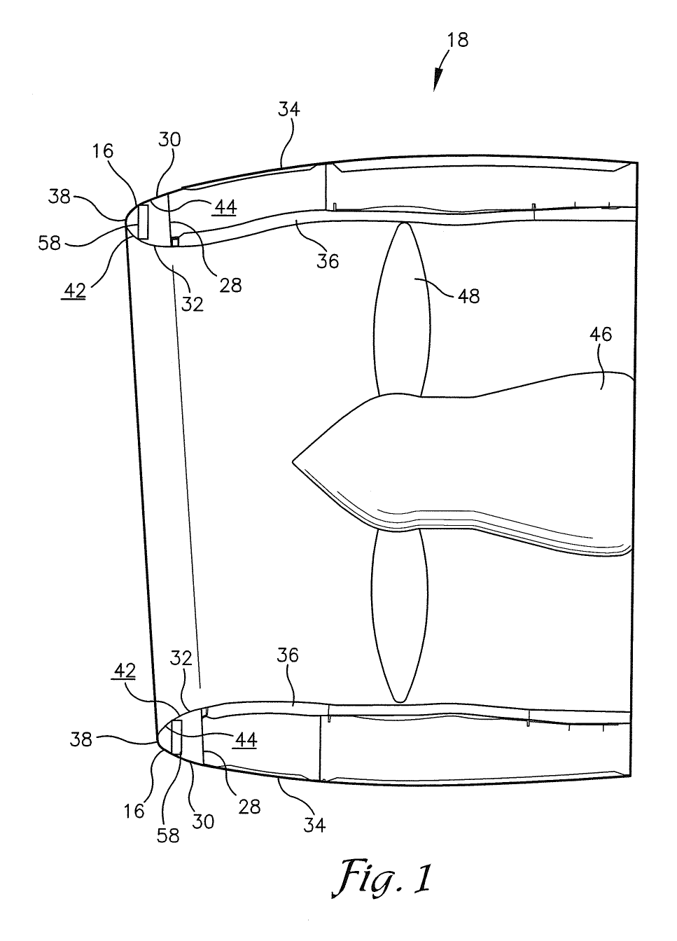

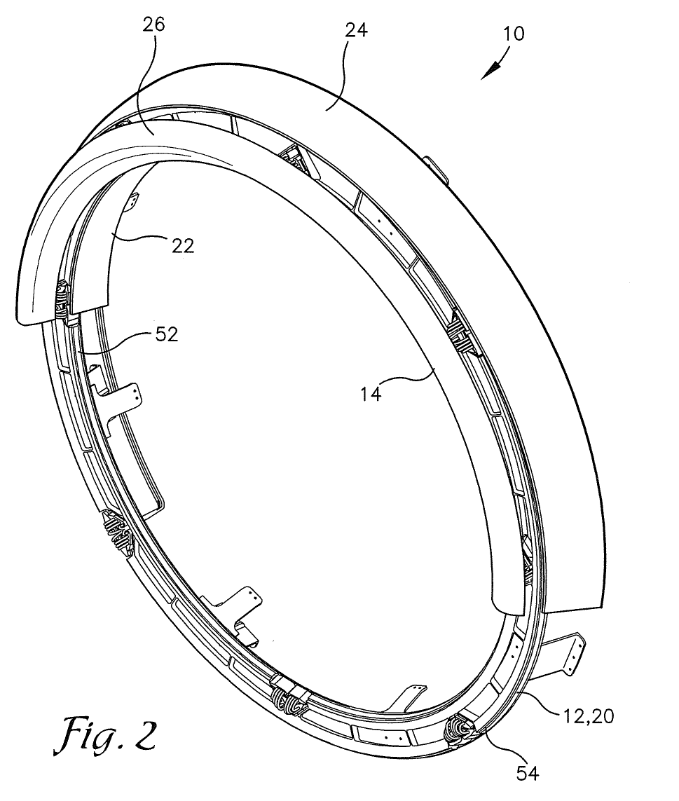

A hybrid ice protection system (HIPS) 10 constructed in accordance with embodiments of the present invention broadly comprises both an electro-expulsive de-icing system (EEDS) 12 and electrothermal heaters 14 positionable within an inlet lip 16 of an aircraft engine nacelle 18, as illustrated in FIG. 1. As illustrated in FIG. 2, the EEDS 12 may include EEDS actuators 20 and the electrothermal heaters 14 may include inner heaters 22, outer heaters 24, and hi-lite heaters 26 which can be selectively activated to provide necessary coverage for specific engine power settings. The actuators 20 may be positioned between the heaters 22-26 such that the actuators 20 (or elements attached thereto) do not strike the heaters 22-26, only the inlet lip 16 itself, thereby reducing wear on the heaters 22-26 and increasing operating lifetime and reliability. The actuators 20 and heaters 22-26 may be arranged and sequenced in a variety of manners, as described below. The HIPS may also comprise a control system 50, as later described herein.

As illustrated in FIG. 1, the inlet lip 16 may be configured to attach to a bulkhead 28 of the engine nacelle 18 and may comprise a substantially continuous lip skin having an outer wall 30 and an inner wall 32. The outer wall 30 may be aligned with and mate flush with an outer inlet skin 34, which is flush with an outer fan cowl of the nacelle 18, and the inner wall 32 may be aligned with and mate flush with an inner inlet skin 36, which is flush with an inner fan case of the nacelle 18. The inner and outer walls 30,32 of the inlet lip 16 may mate at a hi-lite 38, apex, or substantially rounded end of the inlet lip 16, providing an aerodynamic surface for a front end of the nacelle 18. The inlet lip 16 may also comprise and/or be attached to inner and/or outer attachment fasteners configured for attaching the inlet lip 16 to the bulkhead 28, the outer inlet skin 34, and/or the inner inlet skin 36. The inlet lip 16 may also have an outer surface 42 and an inner surface 44. The outer surface 42 may include outer surfaces of the outer wall 30, the inner wall 32, and the hi-lite 38 and the inner surface 44 may include inner surfaces of the outer wall 30, the inner wall 32, and the hi-lite 38. The HIPS 10 may engage the inner surface 44 of the inlet lip 16 in order to break ice off of the outer surface 42 of the inlet lip 16, as later described herein. The inlet lip 16 may be positioned forward of an engine 46 and engine fan 48 of an aircraft. The engine 46 and engine fan 48 may be attached to the nacelle 18 and substantially surrounded by the inner fan case.

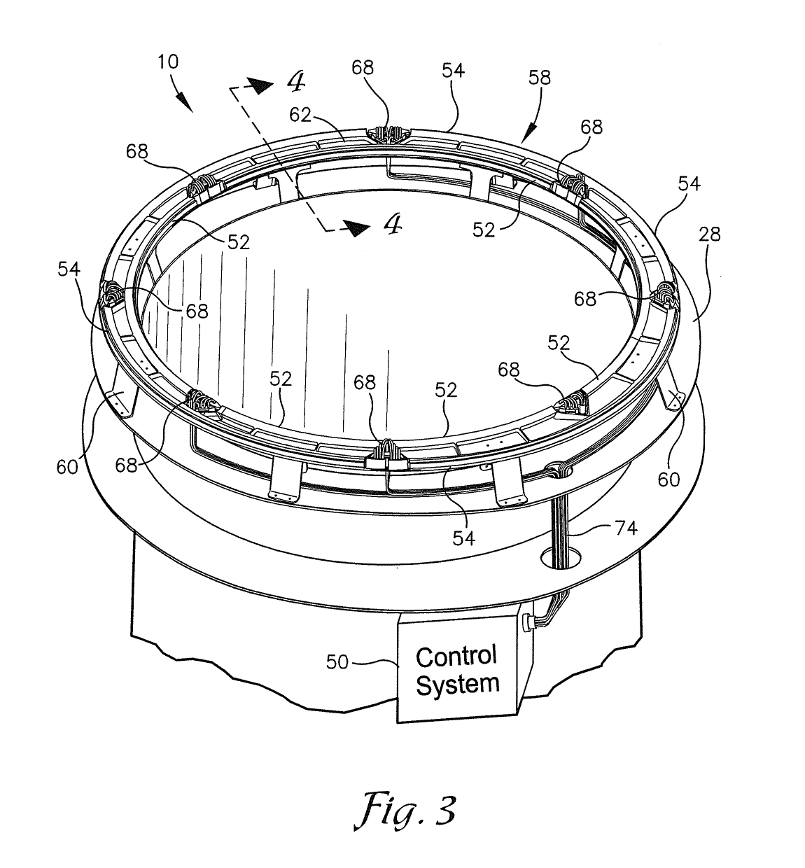

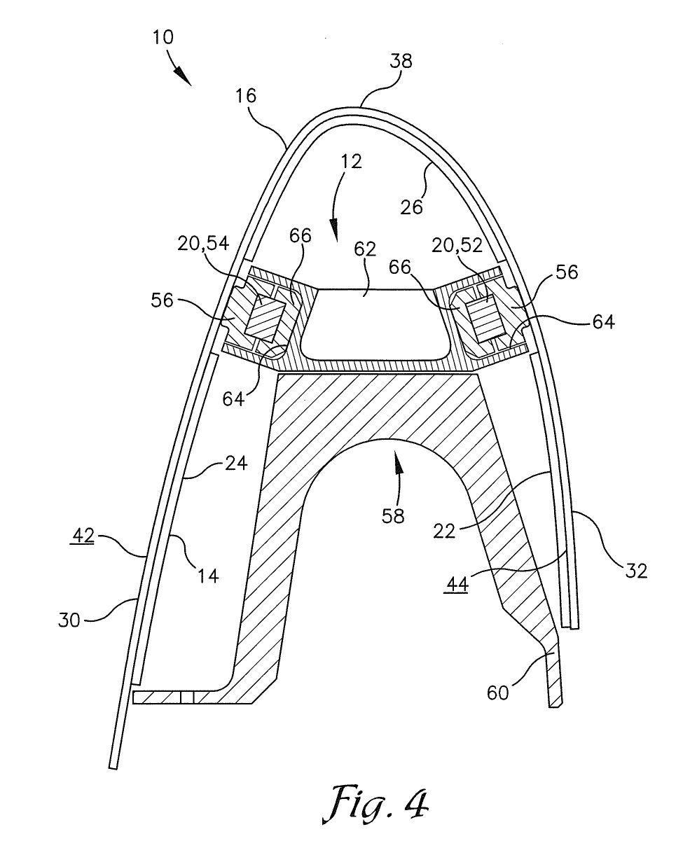

As noted above, the EEDS 12 may comprise a plurality of EEDS actuators 20. Specifically, the EEDS 12 may comprise one or more inner actuators 52 and one or more outer actuators 54, as illustrated in FIGS. 3 and 4. The inner actuators 52 may be positioned slightly aft of the apex 38 of the inlet lip 16 and configured to strike and break ice off of the inner wall 32 of the inlet lip 16. The outer actuators 54 may also be positioned slightly aft of the apex 38 of the inlet lip 16 and configured to strike and break ice off of the outer wall 30 of the inlet lip 16. Each of the actuators 52,54 may comprise a fixed portion fixed relative to the bulkhead 28 by various supports, as later described herein, and a moving portion configured to actuate toward and away from the fixed portion and toward and away from the inlet lip 16.

In some embodiments of the invention, the inner actuators 52 may be circumferentially offset from the outer actuators 54 by 45-degrees about the inlet lip 16, as illustrated in FIG. 3. For example, there may be four inner actuators separated by a small space circumferentially from each other and four outer actuators separated by a small space circumferentially from each other. By staggering the locations of the small spaces between the inner actuators relative to the small spaces between the outer actuators, circumferentially, the actuators more completely protect the inlet lip 16 and particularly the hi-lite 38 thereof. For embodiments of the invention where there are more or less actuators than described in this example, the offset of the outer and inner actuators 52,54 may be more or less than 45-degrees without departing from the scope of the invention.

The EEDS 12 may also comprise a plurality of force transfer units (FTUs) 56 configured to directly impact the inner surface 44 of the inlet lip 16, as illustrated in FIG. 4. The FTUs 56 may be fixed to the movable portion of the actuators 20 and may be positioned and configured to impart actuator impulse force to the inner surface 44 of the lip skin of the inlet lip 16. The FTUs 56 may be any substantially rigid and durable material that does not damage the lip skin of the inlet lip 16. For example, the FTUs 56 may each be made of an abrasion-resistant plastic such as polyethylene or the like, providing a rigid yet non-abrasive surface for striking the inlet lip 16. The FTUs 56 may clip onto, snap onto, or otherwise attach to the moving portion of the actuators 20. Alternatively, the FTUs 56 may be integrally formed with the actuators 20 and/or the actuators 20 may be made of a material suitable for striking the inlet lip 16 without damaging the inner surface 44. The use of FTUs 56 on the actuators 20 may be particularly advantageous in embodiments of the invention in which the actuators 20 are made of copper or some other material that could be damaged or cause damage to the inlet lip 16 if allowed to directly strike the inner surface 44 during operation. Furthermore, the FTUs 56 are not bonded directly to the inlet lip 16, which may allow the inlet lip 16 to be removed without removing the actuators 20 or any structure supporting the actuators 20 and the FTUs 56.

In some embodiments of the invention, the EEDS 12 may further comprise an actuator support assembly (ASA) 58, as illustrated in FIGS. 3-5, for supporting the EEDS actuators 20 and FTUs 56 within the inlet lip 16. The ASA 58 may include a plurality of standoff fittings 60 and a support structure 62. The standoff fittings 60 may be made of machined aluminum and may be configured to secure the EEDS actuators 20 to outer chords or other various portions of the bulkhead 28 of the engine nacelle 18 or to other components of the engine nacelle 18 aside from the inlet lip 16 itself. The standoff fittings 60 may be secured to the support structure 62 made of machined aluminum or other such rigid, durable materials. This support structure 62 may be configured to position the actuators 20 and FTUs 56 within the inlet lip 16 such that the actuators' movement is vector-normal to the inlet lip 16 or inner surface 44 at a point where the actuator strikes the inlet lip 16. The support structure 62 may also be made of metal or some other rigid material and may be one integrally-formed part or may comprise a plurality of support structure pieces mechanically attached to different ones of the standoff fittings 60.

The ASA 58 may also have inner and outer U-channels 64 formed into the support structure 62 and insulated cradles 66 designed to insulate the actuators 20 from the support structure 62. Together, the cradles 66 and the FTUs 56 may encapsulate the actuators 20, providing isolation from the support structure 62 and/or the standoff fittings 60 to prevent arcing. The U-channels 64 and/or cradles 66 may also serve as guides for the actuators 20 and FTUs 56, directing all actuator movement along a single axis or in one degree of freedom normal to the inlet lip 16 inner surface 44 impacted by the FTUs 56. Furthermore, the U-channels 64 and/or cradles 66 may serve as restraints for the fixed portions of the actuators 20. The U-channels 64 may be machined, molded, or otherwise formed into the support structure 62. The cradles 66 may snap into the U-channels 64 and the fixed portions of the actuators 20 may snap into the cradles 66. This may be accomplished with corresponding protrusions and indentions (e.g., grooves and tabs) in the cradles 66 and the U-channels 64 and corresponding protrusions and indentions formed in the cradles 66 and the fixed portions of the actuators 20. However, any method of attaching the U-channels 64 with the cradles 66 and the cradles 66 with the actuators 20 may be used without departing from the scope of the invention.

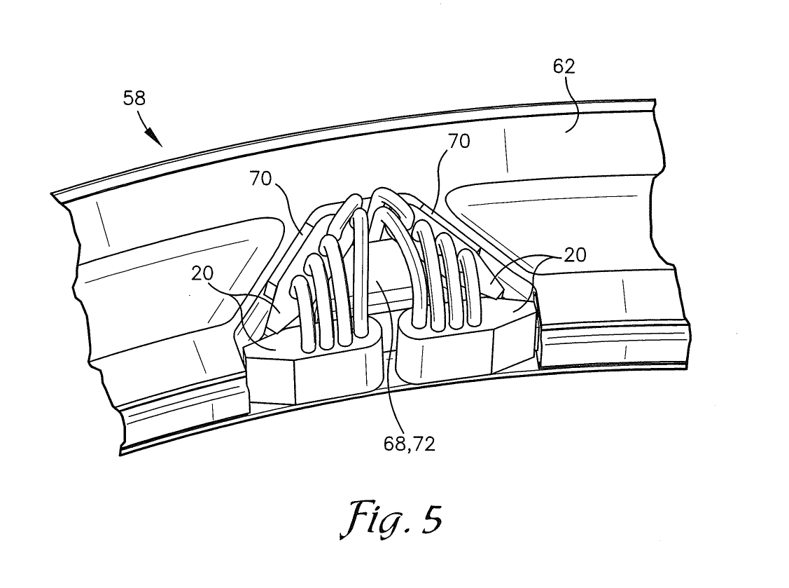

As illustrated in FIGS. 3 and 5, the ASA 58 may also include actuator end supports 68 designed to hold ends of the actuators 20 stable to prevent damage to these actuator ends. The ends of the actuators 20 may be located at the circumferential spaces between the actuators 20. Specifically, the actuator end supports 68 may be configured to restrain movement of the fixed portions of the actuators 20 at the actuator ends and may be configured to reduce movement of the moving portions of the actuators 20 at the actuator ends. As illustrated in FIG. 5, the actuator end supports 68 may comprise a plurality of spacers 70 and an angled or isosceles trapezoid-shaped stabilizing component 72 configured to prevent movement of the actuators 20 in undesired directions. The configuration illustrated in FIG. 5 of the actuator end supports 68 may advantageously minimize the actuators' repulsive force at their ends and restrain the ends of the actuators 20 from excessive movement which can lead to fatigue damage of the actuators 20. However, any configurations of actuator end supports 68 that sufficiently stabilize the actuators 20 at their ends may be used without departing from the scope of the invention. For any actuator end support configuration, keeping the circumferential space between the actuators 20 to a minimum is advantageous, so that circumferential coverage by the EEDS 12 is as large as possible, which is beneficial to the EEDS performance.

As illustrated in FIGS. 2 and 4, the electrothermal heaters 14 may be any heaters known in the art sufficient for heating the inlet lip 16 without causing heat-related damage thereto. The heaters 14 may be attached to the inner surface 44 or in near proximity to the inner surface 44 of the inlet lip 16. Additionally or alternatively, the heaters 14 may be bonded to or embedded into laminate build-up of a composite inlet lip 16. In some embodiments of the invention, each of the heaters 14 may be divided into three or more segments, such as the inner, the outer, and the hi-lite heaters 22-26 noted above. The outer heaters 24 may be positioned in contact with or proximate to the outer wall 30 of the inlet lip 16. The inner heaters 22 may be positioned in contact with or proximate to the inner wall 32 of the inlet lip 16. The hi-lite heaters 26 may be positioned in contact with or proximate to the apex 38 or rounded end of the inlet lip 16 and may even continuously extend through a portion of both the outer and inner walls 30,32 of the inlet lip 16, forward of the inner and outer actuators 52,54. The outer heaters 24 may be positioned aftward of the outer actuators 54 and the hi-lite heaters 26 may be positioned forward of the outer actuators 54, such that the outer actuators 54 are located between the outer and hi-lite heaters 24,26. The inner heaters 22 may be positioned aftward of the inner actuators 52 and the hi-lite heaters 26 may be positioned forward of the inner actuators 52, such that the inner actuators 52 are located between the inner and hi-lite heaters 22,26. Each of the outer, inner, and/or hi-lite heaters 22-26 may be separated into multiple sub elements for ease of manufacturing and installation, and to provide system redundancy. The locations of these heaters 22-26, relative to the EEDS actuator locations, are illustrated in FIG. 2.

In some embodiments of the invention, the electrothermal heaters 14 may be carbon nanomaterial heaters formed on the inner surface 44 of the inlet lip 16 by spraying or otherwise adhering paint thereto which contains carbon nanomaterial. These nanomaterial heaters may have full contact with the lip skin or the inlet lip 16 as opposed to off-the-shelf flat heaters, which must be cut and carefully laid down to approximately cover desired surfaces of the inlet lip 16. The nanomaterial heaters may be segmented into the inner, outer, and hi-lite heaters 22-26, as described above, such that they may be separately and independently heated, allowing select portions of the inlet lip 16 to be heated at different times. However, any types of heaters known in the art for de-icing an inlet lip or other aircraft components may be used without departing from the scope of the invention.

The control system 50, as illustrated in FIG. 3, may include one or more control systems and may be integrated into or interfaced with a full authority digital engine control (FADEC) of the engine 46 or aircraft on which the HIPS 10 is installed. This may provide the HIPS 10 with access to all of the FADEC sensor readings, such that additional instrumentation (e.g., lip skin thermocouples and the like) are not required. The FADEC may provide the control system 50 with information such as airspeed, total temperature, engine power setting, and other parameters which may govern operating characteristics of the HIPS 10. Alternatively, the control system 50 may be the FADEC or the HIPS 10 may have its own independent sensing and control means that are separate from the FADEC without departing from the scope of the invention.

The control system 50 may comprise any number or combination of controllers, circuits, integrated circuits, programmable logic devices such as programmable logic controllers (PLC) or motion programmable logic controllers (MPLC), computers, processors, microcontrollers, transmitters, receivers, other electrical and computing devices, and/or residential or external memory for storing data and other information accessed and/or generated by the HIPS 10. The control system 50 may control operational sequences, power, speed, and/or temperature of the actuators 20 and/or the heaters 22-26 of the HIPS 10.

The control system 50 may be configured to implement any combination of the algorithms, subroutines, or code corresponding to method steps and functions described herein. The control system 50 and computer programs described herein are merely examples of computer equipment and programs that may be used to implement the present invention and may be replaced with or supplemented with other controllers and computer programs without departing from the scope of the present invention. While certain features are described as residing in the control system or FADEC, the invention is not so limited, and those features may be implemented elsewhere. For example, databases may be accessed by the control system 50 for retrieving aircraft data or other operational data without departing from the scope of the invention.

The control system 50 may implement the computer program and/or code segments to perform various method steps described herein. The computer program may comprise an ordered listing of executable instructions for implementing logical functions in the control system 50. The computer program can be embodied in any computer-readable medium for use by or in connection with an instruction execution system, apparatus, or device, and execute the instructions. In the context of this application, a “computer-readable medium” can be any means that can contain, store, communicate, propagate, or transport the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), a portable compact disk read-only memory (CDROM), an optical fiber, multi-media card (MMC), reduced-size multi-media card (RS MMC), secure digital (SD) cards such as microSD or miniSD, and a subscriber identity module (SIM) card.

The residential or external memory may be integral with the control system 50, stand alone memory, or a combination of both. The memory may include, for example, removable and non removable memory elements such as RAM, ROM, flash, magnetic, optical, USB memory devices, MMC cards, RS MMC cards, SD cards such as microSD or miniSD, SIM cards, and/or other memory elements.

As illustrated in FIG. 3, electrical conduits and/or communication conduits 74 may also be secured at or proximate to at least one of the actuator end supports 68 to provide electrical power to the EEDS 12 and/or to provide communication links between the EEDS 12 and the control system 50. Additionally or alternatively, the conduits 74 may be configured for providing electrical power to the electrothermal heaters 14 and/or for facilitating communication between the control system 50 and the electrothermal heaters 14.

In use, the HIPS 10 may be operated in a sequence that takes into account various sensed or known variables. For example, the HIPS 10 may operate the EEDS 12 and the electrothermal heaters 14 according to the power needs of the aircraft systems or expected ice build up at various locations of the inlet lip 16 surfaces, various speeds, altitudes, etc. In some embodiments of the invention, the actuators 20 may first break ice off of a cold surface of the engine inlet lip 16, then the heaters 14 may heat the inlet lip 16 to a predetermined temperature before shutting off. This process may be repeated once a sufficient amount of ice builds up again on the inlet lip 16, as determined by sensors, the FADEC of the aircraft, and/or once a predetermined amount of time has passed. The predetermined amount of time may be based on estimated rates of ice build up in particular sensed or known aircraft conditions. In this example embodiment of the invention, the heaters 14 may be primarily used to remove residual feathers of ice left behind after the EEDS actuators 20 impact the inlet lip 16. Advantageously, removal of this residual ice may require minimal power compared with prior art de-icing systems that use heaters to melt larger quantities of ice. Furthermore, the heaters 14 may be activated in a pulsing fashion so as to greatly reduce the power required versus a stand alone, continuously operating electrothermal system whose heaters run substantially continuously.

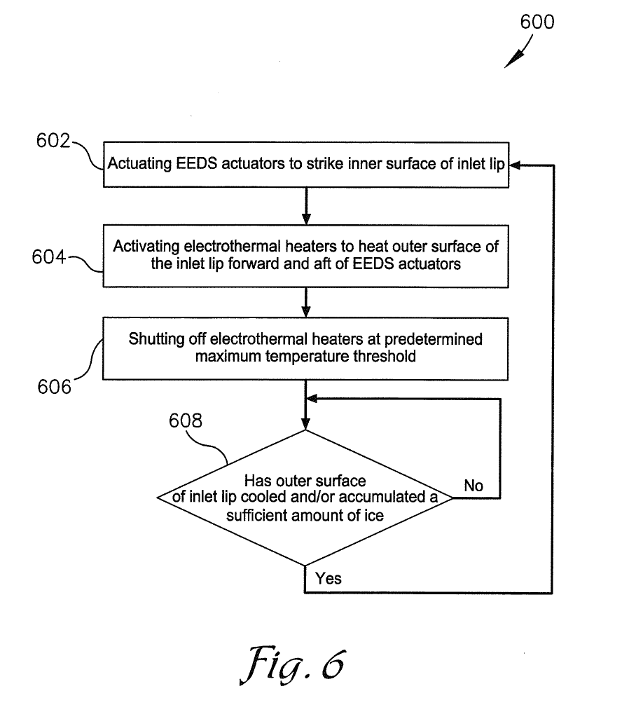

The flow chart of FIG. 6 depicts the steps of an exemplary method 600 for removing ice from an engine nacelle inlet lip 16. In some alternative implementations, the functions noted in the various blocks may occur out of the order depicted in FIG. 6. For example, two blocks shown in succession in FIG. 6 may in fact be executed substantially concurrently, or the blocks may sometimes be executed in the reverse order depending upon the functionality involved.

The method 600, illustrated in FIG. 6, may first include the step of actuating one or more of the EEDS actuators 20 to strike the inner surface 44 of the inlet lip 16, as depicted in block 602. Specifically, the EEDS actuators 20 may strike the FTUs 56 attached thereto against portions of the inner surface 44 of the inlet lip 16 located slightly aft of the apex 38 between the hi-lite heater 26 and the inner and/or outer heaters 22,24. This may break off ice building up on the outer surface 42 of the inlet lip 16. In some embodiments of the invention, the EEDS actuators 20 may be actuated to hit the inlet lip 16 several times to adequately break up and remove a majority of ice build up from the outer surface 42 of the inlet lip 16 prior to activation of the electrothermal heaters 14. Residual amounts of ice or ice feathers may still remain on the outer surface 42 of the inlet lip 16 after the EEDS actuators 20 break a majority of the ice buildup therefrom.

Therefore, the method 600 may further comprise the step of activating one or more of the electrothermal heaters 14 to heat the outer surface 42 of the inlet lip 16 outward of and between locations where the EEDS actuators 20 strike the inlet lip 16, as depicted in block 604. This step may be performed after the step of actuating the EEDS actuators 20, thereby melting residual ice or ice feathers from the outer surface 42 of the inlet lip 16. For example, the EEDS actuators 20 may be actuated when the outer surface 42 of the inlet lip 16 is at or below a predetermined temperature and/or has a predetermined amount of ice built up thereon. Then, once an adequate amount of ice breaks off of the inlet lip 16 or the EEDS actuators 20 have been actuated to facilitate a predetermined number of strikes of the inlet lip 16, the electrothermal heaters 14 may be activated to melt the residual ice remaining on the outer surface 42 of the inlet lip 16.

Next, the method 600 may comprise a step of shutting off the electrothermal heaters 14 at a predetermined maximum temperature threshold, as depicted in block 606. In some embodiments of the invention, the heaters 14 may be operated until the inlet lip 16 outer surface temperature thermocouples measure a specific temperature or maximum threshold temperature, at which time the heaters 14 may be deactivated until the next cycle. However, a heater activation time required to achieve a necessary surface temperature may be determined as a function of free stream total temperature, airspeed, and/or other parameters as necessary such that successful operation of the HIPS heaters 14 may be conducted without the use of monitoring thermocouples attached to the inlet lip 16.

Then, the method 600 may include the step of determining if the outer surface 42 of the inlet lip 16 has cooled and/or has accumulated a sufficient amount of ice, as depicted in block 608, and actuating the EEDS actuators 20 once one or more of these conditions has occurred. A variety of estimated, sensed, or pre-determined variables may be used to determine when to again actuate the EEDS actuators 20, as in block 602. For example, the EEDS actuators 20 may be actuated again at a predetermined length of time after shutting off the electrothermal heaters 14, once sensors or other variables indicate that the outer surface 42 of the inlet lip 16 has cooled again to a predetermined temperature, and/or once a predetermined amount of ice builds up again on the outer surface 42 of the inlet lip 16. The method 600 may be repeated a plurality of times as needed throughout operation of the aircraft, as illustrated in FIG. 6. However, note that various sequences may be employed by the HIPS 10 without departing from the scope of the invention. Furthermore, the sequence of independently actuating the EEDS actuators 20 and independently activating the electrothermal heaters 14 may be determined by the HIPS control system 50 or FADEC based on various flight conditions.

At high engine power settings, a stagnation point of airflow entering the engine 46 may move to a point on the outer wall 30 of the inlet lip 16, while at low power settings the stagnation point may move to a point on the inner wall 32 of the inlet lip 16. This movement of the stagnation point may directly influence impingement of water droplets and, therefore, a location of ice accretion. The inner, outer, and hi-lite heaters 22-26, as well as the inner and outer EEDS actuators 52,54, can be selectively activated to provide necessary coverage for these different engine power settings, further reducing the power requirements of the system. For example, the outer EEDS actuators 20 may be activated to remove ice building on the outer wall 30 of the inlet lip 16 at a high engine power setting, followed by activation of the outer and/or hi-lite heaters 24,26 to remove residual ice from the outer wall 30 of the inlet lip 16, while the inner heaters 22 and the inner EEDS actuators 52 may not be used or may be used at more distant time intervals than the outer actuators and heaters 54,24.

The primary ice removal method of the HIPS 10 may be the EEDS actuators 20, with a secondary removal of residual ice accomplished by low-power pulsing of the HIPS heaters 14. Thus, the heaters 14 require relatively little power to remove only residual ice. Advantageously, test observations show that ice breaks away more effectively on a cold surface (such as that from HIPS 10) when struck by elements of the EEDS 12 than on a heated surface. The HIPS 10 described herein also requires fewer actuators than prior art systems because the EEDS actuators 20 are able to be conformed to a complex curvature of the inlet lip geometry. The EEDS actuators 20 may extend 90□ around a circumference of the inlet lip 16, reducing part count, weight, and gaps in actuator coverage. Typical prior art actuators are unable to conform to a compound curvature and, therefore, must be separated into more elements.

Although the invention has been described with reference to the particular embodiments, it is noted that equivalents may be employed and substitutions made herein without departing from the scope of the invention. Specifically, the HIPS 10 is described herein for use on an aircraft engine inlet, but the apparatus and method described herein could be used for de-icing any aircraft skin. For example, other potential applications may include ice protection of wings and tail surfaces, turboprop or piston engine inlets and cooling openings, propeller blades, radomes and nosecones, wind turbine blades and nacelles, and other surfaces susceptible to ice accretion in service. Furthermore, the HIPS 10 can additionally or alternatively be operated as an independent EEDS-only or electrothermal-only system if desired, and with appropriately designed control systems could be tailored to suit the needs of specific conditions.

Having thus described various embodiments of the invention, what is claimed as new and desired to be protected by Letters Patent includes the following:

1. An ice protection system for removing ice from an outer surface of an aircraft skin, the ice protection system comprising:
an electro-expulsive de-icing system (EEDS) having a plurality of EEDS actuators positioned to provide striking force to an inner surface of the aircraft skin; and
electrothermal heaters positioned to heat the aircraft skin at areas between locations where the EEDS actuators are positioned to provide striking force.

2. The ice protection system of claim 1, further comprising a control system configured to activate at least one of the EEDS actuators to provide striking force to the aircraft skin while the aircraft skin is at or below a predetermined temperature.

3. The ice protection system of claim 2, wherein the control system is further configured to activate at least one of the electrothermal heaters following activation of the at least one of the EEDS actuators.

4. The ice protection system of claim 1, further comprising force transfer units (FTUs) configured to be positioned between the EEDS actuators and the inner surface of the aircraft skin, such that striking force provided by the EEDS actuators is provided via the FTUs, causing the FTUs to directly impact the inner surface of the aircraft skin.

5. The ice protection system of claim 1, further comprising an actuator support assembly (ASA) configured to mount the EEDS actuators to a structural component of an aircraft other than the aircraft skin.

6. The ice protection system of claim 5, wherein the ASA comprises a plurality of offset fittings attached to the structural component of the aircraft and a support structure attached to the offset fittings, wherein the EEDS actuators are attached to the support structure and oriented in a configuration such that a striking movement of each of the EEDS actuators is in a direction vector-normal to a portion of the aircraft skin struck thereby.

7. The ice protection system of claim 1, wherein the EEDS actuators comprise outer actuators arranged in a circular configuration circumferentially spaced relative to each other and inner actuators arranged in a circular configuration circumferentially spaced relative to each other and radially spaced a distance concentrically inward from the outer actuators.

8. The ice protection system of claim 7, wherein the circumferential spacing between the outer actuators is circumferentially offset by a particular amount of degrees from the circumferential spacing between the inner actuators.

9. The ice protection system of claim 1, wherein the electrothermal heaters are carbon nanomaterial heaters containing carbon nanomaterial.

10. The ice protection system of claim 7, wherein the electrothermal heaters comprise inner heaters, hi-lite heaters, and outer heaters, wherein the inner actuators are configured to provide striking force to the aircraft skin between the inner heaters and the hi-lite heaters and the outer actuators are configured to provide striking force to the aircraft skin between the outer heaters and the hi-lite heaters.

11. The ice protection system of claim 10, wherein the electrothermal heaters are operable to be independently activated relative to each other and the EEDS actuators are operable to be independently actuated relative to each other.

12. A method for expelling ice from an outer surface of an inlet of an engine nacelle, the method comprising:
actuating at least one of a plurality of electro-expulsive de-icing system (EEDS) actuators to strike an inner surface of the inlet; and
activating at least one of a plurality of electrothermal heaters to heat the outer surface of the inlet between locations where the EEDS actuators strike the inlet after actuating the EEDS actuators.

13. The method of claim 12, further comprising actuating at least one of the EEDS actuators to strike the inner surface of the inlet when the outer surface of the inlet is at least one of at or below a predetermined temperature and has a predetermined amount of ice built up thereon.

14. The method of claim 12, wherein the at least one of the electrothermal heaters is only activated if less than a maximum amount of residual ice build up is present on the outer surface of the inlet, wherein the electrothermal heaters are shut off once a predetermined maximum threshold temperature is reached.

15. The method of claim 12, further comprising shutting off the at least one of the plurality of electrothermal heaters and actuating the at least one of the plurality of EEDS actuators: at a predetermined length of time after shutting off the at least one of the plurality of electrothermal heaters, once the outer surface of the inlet cools to a predetermined temperature, or once a predetermined amount of ice builds up again on the outer surface of the inlet.

16. The method of claim 12, wherein the EEDS actuators comprise outer actuators configured to break ice off of an outer wall of the inlet and inner actuators configured to break ice off of an inner wall of the inlet, wherein the method further comprises actuating the outer and inner actuators independently depending on a power setting of an engine fixed within the engine nacelle and an associated stagnation point of airflow on the inlet.

17. The method of claim 12, wherein the electrothermal heaters comprise outer heaters configured to melt residual ice off of an outer wall of the inlet, hi-lite heaters configured to melt residual ice off of a nose or hi-lite portion of the inlet, and inner heaters configured to melt residual ice off of an inner wall of the inlet, wherein the method further comprises actuating one or more of the outer, hi-lite, and inner heaters independently depending on a power setting of an engine fixed within the engine nacelle and an associated stagnation point of airflow on the inlet.

18. An ice protection system for removing ice from an outer surface of an inlet lip of an engine nacelle, the ice protection system comprising:
an electro-expulsive de-icing system (EEDS) having a plurality of EEDS actuators positioned to provide striking force to an inner surface of the inlet lip;
electrothermal heaters positioned to heat the inlet lip at areas between locations where the EEDS actuators are positioned to provide striking force; and
a control system configured to actuate at least one of the EEDS actuators to provide striking force to the inner surface of the inlet lip when the inlet lip is at or below a predetermined temperature and configured to command removal of residual ice remaining on the outer surface of the inlet lip after actuation of the EEDS actuators by activating at least one of the electrothermal heaters following actuation of the EEDS actuators.

19. The ice protection system of claim 18, further comprising an actuator support assembly (ASA) configured to mount the EEDS actuators to a bulkhead of the engine nacelle, wherein the ASA comprises a plurality of offset fittings attached to the bulkhead and a support structure attached to the offset fittings, wherein the EEDS actuators are attached to the support structure and oriented in a configuration such that a striking movement of each of the EEDS actuators is in a direction vector-normal to a portion of the inlet lip struck thereby.

20. The ice protection system of claim 18, wherein the EEDS actuators comprise outer actuators arranged in a circular configuration circumferentially spaced relative to each other and inner actuators arranged in a circular configuration circumferentially spaced relative to each other and radially spaced a distance concentrically inward from the outer actuators, wherein the circumferential spacing between the outer actuators is circumferentially offset by a particular amount of degrees from the circumferential spacing between the inner actuators.

21. The ice protection system of claim 18, wherein the electrothermal heaters are carbon nanomaterial heaters containing carbon nanomaterial.

22. The ice protection system of claim 7, wherein the electrothermal heaters comprise inner heaters, hi-lite heaters, and outer heaters, wherein the inner actuators are configured to provide striking force to the inlet lip between the inner heaters and the hi-lite heaters and the outer actuators are configured to provide striking force to the inlet lip between the outer heaters and the hi-lite heaters, wherein the electrothermal heaters are operable to be independently activated relative to each other and the EEDS actuators are operable to be independently actuated relative to each other.
